(19) United States
(12) Patent Application Publication
(10) Pub. No.: US 2025/0267042 A1
(43) Pub. Date: Aug. 21, 2025

(54) SYSTEM AND METHOD FOR CHANNEL ESTIMATION IN PHYSICAL LAYER PROCESSING

(71) Applicant: Samsung Electronics Co., Ltd., Suwon-si (KR)

(72) Inventors: Shivaji KANT, Bangalore (IN); Rajeev Ranian KUMAR, Bangalore (IN)

(21) Appl. No.: 19/040,486

(22) Filed: Jan. 29, 2025

Related U.S. Application Data
(63) Continuation of application No. PCT/KR2025/001122, filed on Jan. 21, 2025.

(30) Foreign Application Priority Data
Feb. 17, 2024 (IN) 202441011157

(51) Int. Cl. H04L 25/02; H04W 72/044

(52) U.S. Cl. CPC H04L 25/0224; H04W 72/046

(57) ABSTRACT

Disclosed is a method implemented in a user equipment (UE) for channel estimation in physical layer processing. The method may include: receiving a data packet from a next generation node B (gNB) for the physical layer processing; initiating the physical layer processing of the received data packet; transmitting a message including at least one channel quality information (CQI) report and one or more network parameters to the gNB; receiving channel information from the gNB, wherein the channel information is determined using the at least one of the CQI report, the one or more network parameters, and an uplink packet transmitted by the UE on an uplink channel; and selecting a channel estimation technique based on the received channel information.

### CROSS-REFERENCE TO RELATED APPLICATIONS

This application is a continuation of International Application No. PCT/KR2025/001122 designating the United States, filed on Jan. 21, 2025, in the Korean Intellectual Property Receiving Office and claiming priority to Indian Patent Application number 202441011157, filed on Feb. 17, 2024, in the Indian Patent Office, the disclosures of each of which are incorporated by reference herein in their entireties.

### BACKGROUND

### Field

The disclosure relates to the field of wireless communication systems. For example, the disclosure relates to a system and method for channel estimation in physical layer processing.

### Description of Related Art

In a fifth generation (5G) new radio (NR) protocol stack, a physical layer (PHY layer or layer 1 (L1)) allows the transmission and reception of radio signals over a wireless medium. In communication, the PHY layer is located at the bottom of the 5G NR protocol stack, interfacing with medium access control (MAC) sublayer via transport channels. Further, the PHY layer provides its services to the MAC sublayer and is configured by radio resource control (RRC). Further, the PHY layer supports downlink (next generation node B (gNB)-to-user equipment (UE)), uplink (UE-to-gNB), and sidelink (UE-to-UE) communications. For example, the downlink channels may be physical downlink shared channel (PDSCH), physical downlink control channel (PDCCH), and physical broadcast channel (PBCH). The uplink channels may be physical random-access channel (PRACH), physical uplink shared channel (PUSCH), and physical uplink control channel (PUCCH). Further, the PHY layer plays an important role in converting the data into a format suitable for transmission over the wireless medium. Also, the PHY layer performs a set of operations, such as coding, modulation, and synchronization to ensure reliable communication between multiple devices.

FIG. 1A is a block diagram illustrating an example L1 processing 100, according to the existing state of the art. As shown, FIG. 1A shows the example L1 processing 100 block diagram for PDSCH receive (Rx) multiple-input multiple-output (MIMO)-orthogonal frequency division multiplexing (OFDM) based channel. The L1 processing 100 includes a set of computations, such as cyclic prefix removal 102, fast Fourier transform (FFT) 104, user de-mapping 106, channel estimation 108, equalization 110, demodulation 112, descrambling 114, rate de-matching 116, low density parity check (LDPC) decoding 118, and cyclic redundancy check (CRC) 120. Further, most of the set of computations are intensive and require a lot of time and power from a processing unit.

FIG. 1B is a block diagram illustrating an example process of performing channel estimation 122, according to the existing state of the art. As depicted in FIG. 1B, the process of performing the channel estimation 122 includes demodulation reference signals (DMRS) extraction 124, power boosting 126, DMRS generation 128, de-spread 130, phase compensation 132, interpolation 134, signal-to-noise ratio (SNR) estimation 136, and frequency correction 138. The channel estimation is targeted towards calculating the channel coefficients through the estimation theory. This also involves inclusion and usage of different techniques with a trade-off between accuracy and computational time.

Further, there are multiple estimation methods that are based on training pilots. Such estimation methods are applicable in systems where the transmitter sends a certain, known signal. These known transmitted signals are called as pilot signals. The process of estimating the channel parameters with the help of these received symbols or pilots is called channel estimation. Estimation of the channel based on the training pilots may be achieved either by inserting pilot tones in all the OFDM symbols' subcarriers with a specific period or by inserting pilot tones in each OFDM symbol. The insertion configuration of these pilot tones in a frame may vary as per the requirement of the system.

Furthermore, the channel estimation technique is often expected to deliver a combination of high data rate support and a low error rate. The high data rate support may be achieved if the channel estimation technique is quick. Further, the low error rate may be achieved if the channel estimation technique is highly precise, which in turn requires application of mathematically complex techniques. Thus, OFDM systems require the use of estimators that have both low complexity and high precision. Thus, the estimators are generally adopted in the OFDM systems to achieve the compromise between complexity and precision. For example, an increase in runtime and power consumption results in an increase in channel estimation complexity and an increase in the channel estimation precision. Further, a decrease in channel estimation precision results in in decrease in channel estimation complexity and the decrease/increase in power consumption depending on channel conditions. The two basic 1D estimators are the estimators based on block-type pilots and the comb estimator. Further, block-type estimators may be based on the least squares (LS) method, minimal mean squared error (MMSE), and the modified MMSE. Furthermore, the estimators based on comb-type pilots include the LS estimator with 1D interpolation, a maximum likelihood estimator (MLE), and a parametric channel modelling based (PCMB) estimator.

Further, the channel estimation technique uses mathematical calculations, such as a least square operation, a minimum mean square operation, a correlation operation, complex number vector multiplication, matrix multiplication, and matrix inversion. These mathematical calculations require extensive computations. For example, the matrix inversion requires extensive computations and multiple techniques, such as matrix decomposition using cholesky, QR, LU, and the like are employed to reduce such computations. Furthermore, there are major computational challenges for estimating the communication channel. For example, the channel estimation results in significant power consumption both at the UE side and gNB side. With the increasing frequency bands and high data rates, current frames now occupy a very small-time interval. Also, such frames are required to be decoded with less transmission time interval.

Furthermore, in conventional solutions, the high precision channel estimation is applied for all the channels each time which results in significant power consumption both at the UE and gNB side. However, there are multiple use cases in which the high precision channel estimation is not required to be applied for all the channels. For example, when the UE is in a clear line of sight with not many obstructive elements present in the channel (environment), the channel tends to remain constant for such a small duration of a received frame. This does not require the re-computation of the channel parameter coefficients using channel estimation technique for each received frame. In another example, when a user employs communication techniques for industrial communication and a static communication environment, the control units for each of the machines are located at stationary mounts. Thus, the channel conditions between such control units (or communication units) are mostly static and need not vary for such a small duration of a frame we receive. This does not require the re-computation of the channel parameter using channel estimation technique for each received frame. Further, the re-computation of the channel parameter is also not required when the UE has no mobility and is in less a disturbing environment. The stationary objects ensure less changing channel parameters in a static environment, such as mobile kept on a desk, table, or in an idle state. Furthermore, the re-computation of the channel parameter is also not required when the UE is in a good beam formed by gNB. In such cases, the strong beamforming ensures good communication channels and high-power transmissions. Also, the channel parameters are less likely to vary between the gNB and the user. In such cases, the previously estimated channel coefficients and a low prevision channel estimation technique may be applied.

Therefore, there is a need to address the above-discussed problems associated with the channel estimation in physical layer processing.

### SUMMARY

According to an example embodiment of the disclosure, disclosed is a method implemented in a user equipment (UE) for channel estimation in physical layer processing. The method includes: receiving a data packet from a next generation node B (gNB) for the physical layer processing; initiating the physical layer processing of the received data packet; transmitting a message including at least one channel quality information (CQI) report and one or more network parameters to the gNB; receiving channel information from the gNB, wherein the channel information is identified using the at least one of the CQI report, the one or more network parameters, and an uplink packet transmitted the UE on an uplink channel; and selecting a channel estimation technique based on the received channel information.

According to an example embodiment of the disclosure, disclosed is a user equipment (UE) for performing channel estimation in physical layer processing. The UE comprises: memory storing instructions and at least one processor, comprising processing circuitry, wherein the instructions, when executed by at least one processor individually and/or collectively, cause the UE to: receive a data packet from a next generation node B (gNB) for the physical layer processing; initiate the physical layer processing of the received data packet; control the UE transmit a message including at least one channel quality information (CQI) report and one or more network parameters to the gNB; control the UE to receive channel information from the gNB, wherein the channel information is identified using the at least one of the CQI report, the one or more network parameters, and an uplink packet transmitted by the UE on a uplink channel; and select a channel estimation technique based on the received channel information.

According to an example embodiment of the disclosure, disclosed is a non-transitory computer-readable storage medium storing one or more programs comprising instructions. The instructions, when executed by at least one processor individually and/or collectively, cause the UE to: receive a data packet from a next generation node B (gNB) for the physical layer processing; initiate the physical layer processing of the received data packet; transmit a message including at least one channel quality information (CQI) report and one or more network parameters to the gNB; receive a channel information from the gNB, wherein the channel information is identified using the at least one of the CQI report, the one or more network parameters, and an uplink packet transmitted by the UE on an uplink channel; and select a channel estimation technique based on the received channel information.

To further clarify the advantages and features of the disclosure, a more particular description of various example embodiments illustrated in the appended drawings is provided. It is appreciated that these drawings depict example embodiments and are therefore not to be considered limiting its scope. The disclosure will be described and explained with additional specificity and detail with reference to the accompanying drawings.

### BRIEF DESCRIPTION OF THE DRAWINGS

The above and other features, aspects, and advantages of certain embodiments of the disclosure will be more apparent from the following detailed description, taken in conjunction with the accompanying drawings in which like characters represent like parts throughout the drawings, an in which:

FIG. 1A is a block diagram illustrating an example L1 processing, according to the existing state of the related art;

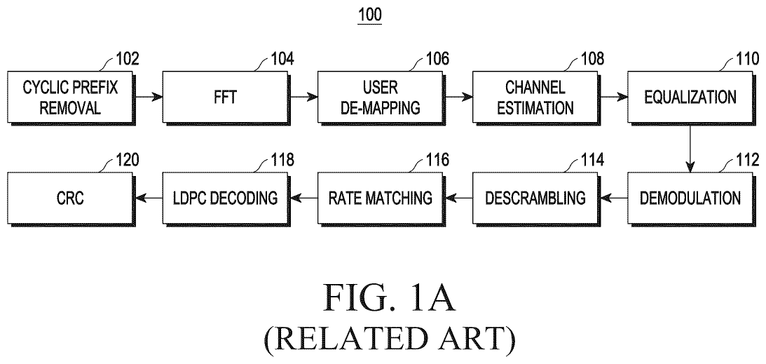

FIG. 1B is a block diagram illustrating an example process of performing channel estimation, according to the existing state of the related art;

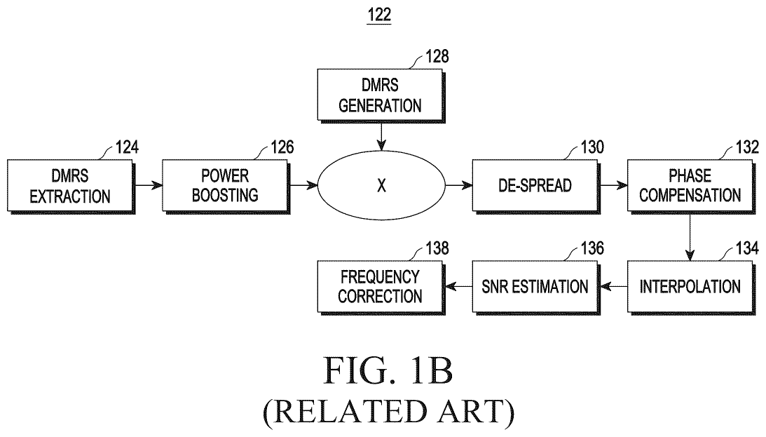

FIG. 2 is a block diagram illustrating an example configuration of a user equipment (UE) for channel estimation in physical layer processing, according to various embodiments;

FIG. 3 is a flowchart illustrating an example technique of selecting a channel estimation based on channel information, according to various embodiments;

FIG. 4 is a diagram illustrating example operations performed by the UE for performing the channel estimation, according to various embodiments;

FIG. 5 is a signal flow diagram illustrating example operations performed by the UE for performing the channel estimation, according to various embodiments; and

FIG. 6 is a flowchart illustrating an example method for performing channel estimation, according to various embodiments.

Further, skilled artisans will appreciate that elements in the drawings are illustrated for simplicity and may not have necessarily been drawn to scale. For example, the flowcharts illustrate the method in terms of the steps/operations involved to help to improve understanding of aspects of the disclosure. Furthermore, in terms of the construction of the device, one or more components of the device may have been represented in the drawings by conventional symbols, and the drawings may show those specific details that are pertinent to understanding the various embodiments of the disclosure so as not to obscure the drawings with details that will be readily apparent to those of ordinary skill in the art having the benefit of the description herein.

### DETAILED DESCRIPTION

It should be understood at the outset that although illustrative implementations of the various example embodiments of the disclosure are illustrated below, the disclosure may be implemented using any number of techniques, whether currently known or in existence. The disclosure should in no way be limited to the illustrative implementations, drawings, and techniques illustrated below, including the example design and implementation illustrated and described herein, but may be modified within the scope of the appended claims along with their full scope of equivalents.

The term “some” as used herein may refer, for example, to “none, or one, or more than one, or all.” Accordingly, the terms “none,” “one,” “more than one,” “more than one, but not all” or “all” would all fall under the definition of “some.” The term “some embodiments” may refer to one embodiment, to several embodiments or to all embodiments. Accordingly, the term “some embodiments” may refer to “no embodiment, or one embodiment, or more than one embodiment, or all embodiments.”

The terminology and structure employed herein is for describing, teaching, and illuminating various embodiments and their specific features and elements and does not limit, restrict, or reduce the spirit and scope of the claims or their equivalents.

For example, any terms used herein such as but not limited to “includes,” “comprises,” “has,” “have,” and grammatical variants thereof do not specify an exact limitation or restriction and certainly do not exclude the possible addition of one or more features or elements, unless otherwise stated, and furthermore must not be taken to exclude the possible removal of one or more of the listed features and elements, unless otherwise stated with the limiting language “must comprise” or “need to include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element does not preclude there being none of that feature or element, unless otherwise specified by limiting language such as “there needs to be one or more” or “one or more element is required.”

Unless otherwise defined, all terms, and especially any technical and/or scientific terms, used herein may be taken to have the same meaning as commonly understood by one having ordinary skill in the art.

Embodiments of the disclosure will be described in greater detail below with reference to the accompanying drawings.

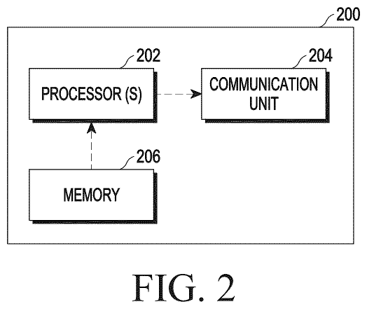

FIG. 2 is a block diagram illustrating an example configuration of a user equipment (UE) 200 for channel estimation in physical layer processing, according to various embodiments. The example block diagram of the UE 200 as shown in FIG. 2 may be understood as a part of the configuration of the UE 200. Hereinafter, it is understood that terms including “unit” or “module” as illustrated in the drawings may refer to the unit for processing at least one function or operation and may be implemented in a hardware, software, or a combination of hardware and software.

Referring to FIG. 2, the UE 200 may include one or more processors (e.g., including processing circuitry) 202, a communication unit (e.g., including communication circuitry) 204 (e.g., a communicator or a communication interface), and a memory 206. By way of example, the UE 200 may be an electronic device, such as, for example, and without limitation, a cellular phone, a mobile phone, a smartphone, a tablet, a computing device, personal digital assistance (PDA), or other devices that may communicate over cellular networks (such as a 3G, 4G, 5G, 6G and beyond 6G networks or any future wireless communication network). The communication unit 204 may perform functions for transmitting and receiving signals via a wireless channel.

As an example, the one or more processors 202 may be a single processing unit or a number of units, all of which could include multiple computing units. The one or more processors 202 may be implemented as one or more microprocessors, microcomputers, microcontrollers, digital signal processors, central processing units, state machines, logic circuitries, and/or any devices that manipulate signals based on operational instructions. Among other capabilities, the one or more processors 202 are configured to fetch and execute computer-readable instructions and data stored in the memory 206. The one or more processors 202 may include one or a plurality of processors. At this time, the one or more processors 202 may be a general-purpose processor, such as a central processing unit (CPU), an application processor (AP), or the like, a graphics-only processing unit such as a graphics processing unit (GPU), a visual processing unit (VPU), and/or an artificial intelligence (AI)-dedicated processor such as a Neural Processing Unit (NPU). The one or more processors 202 may control the processing of the input data in accordance with a specified operating rule or AI model stored in the non-volatile memory and the volatile memory. The specified operating rule or artificial intelligence model is provided through training or learning. Furthermore, the processor(s) 202 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 206 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

Various example embodiments disclosed herein may be implemented using processing circuitry. For example, some example embodiments disclosed herein may be implemented using at least one software program running on at least one hardware device and performing network management functions to control the elements.

In an embodiment of the disclosure, the one or more processors 202 of the UE 200 are configured to receive a data packet from a next generation node B (gNB) for the physical layer processing. In an embodiment of the disclosure, the physical layer processing may refer, for example, to the set of operations and manipulations performed at the physical layer (L1) of a communication system.

Further, the one or more processors 202 may be configured to initiate the physical layer processing of the received data packet.

Furthermore, the one or more processors 202 may be configured to transmit a message including a channel quality information (CQI) report and one or more network parameters to the gNB or the base station. In an embodiment of the disclosure, the network assesses the quality of the radio channel between the UE 200 and the base station. The CQI report provides information about the channel conditions, allowing the network to optimize various aspects of the communication link. In an example embodiment of the disclosure, the one or more network parameters may include an estimated frequency offset, a phase offset, an observed Doppler shift, or any combination thereof. In an embodiment of the disclosure, a decision engine of the gNB or the base station is informed of the channel status between the gNB and the UE 200 based on the transmitted message. Also, this may be supplemented by the similar parameters calculated at the gNB end for the uplink frames received from the UE 200. This information may significantly improve the decision-making qualities for channel classification by the decision engine.

For example, as per the specification TR 138 901—V14.3.0—5G, the one or more network parameters are used to model different channel categories. However, the one or more network parameters are not communicated to the UE 200 rather act as a static guide for standardization of L1 processing. If a tapped delay channel (TDL) channel model is considered in see 7.7.2 of the TR 138 901—V14.3.0—5G specification, the Doppler shift is considered. Three TDL models, namely TDL-A, TDL-B and TDL-C, are constructed to represent three different channel profiles for non-line of sight (NLOS) while TDL-D and TDL-E are constructed for line of sight (LOS). The Doppler spectrum for each tap is characterized by a classical (Jakes) spectrum shape and a maximum Doppler shift f_d where f_d=|v⁻|λ_0. These TDL models are normalized and may be scaled in delay so that a desired root mean square (RMS) delay spread may be achieved using equation (1):

$${τ}_{n . scaled} = {τ}_{n . model} . {DS}_{desired} \qquad ( 1 )$$

In equation (1), τ_{n. scaled} is a normalized delay value of the nth cluster in a CDL model or the TDL model. Further, τ_{n. model} is a new delay value (in [ns]) of the nth cluster. Furthermore, DS_{desired} is the required delay spread (in [ns]).

In an embodiment of the disclosure, Table 1 illustrates various models for fading channels and their corresponding DS_{desired}. Further, the example parameters given in Table 1 do not preclude the use of other scaling values if found suitable. For instance, if additional scenarios are introduced or if the effect of beamforming is required to be captured in the TDL. Both examples may potentially result in an increased range of experienced RMS delay spreads.

TABLE 1

| Model | DS_{desired} | |
|---|---|---|
| Very short delay spread | 10 | ns |
| Short delay spread | 30 | ns |
| Nominal delay spread | 100 | ns |
| Long delay spread | 300 | ns |
| Very long delay spread | 1000 | ns |

Further, the one or more processors 202 may be configured to receive channel information from the gNB. In an embodiment of the disclosure, the channel information is computed using the CQI report, the one or more network parameters, and an uplink packet received by the gNB from the UE 200 on an uplink channel, or any combination thereof.

Further, the one or more processors 202 may be configured to select a channel estimation technique based on the received channel information.

Further, the one or more processors 202 may be configured to transmit, upon completing the physical layer processing, the data packet to an upper layer of the UE based on the selected channel estimation technique.

In selecting the channel estimation technique based on the received channel information, the one or more processors 202 may be configured to receive one or more updated transmission parameters from the gNB. In an embodiment of the disclosure, the gNB takes its input from multiple sources, such as CQI report, synchronization signal block (SSB) reporting (beamforming information), noise and interference power information, signal-to-interference-plus-noise ratio (SINR), or the like.

In an embodiment of the disclosure, one or more transmission parameters are updated by the gNB based on the channel information. In an example embodiment of the disclosure, the one or more updated transmission parameters include demodulation reference signal (DMRS) configuration, signal-to-noise ratio for one or more transmission parameters, transmission bandwidth prioritization, one or more beamforming parameters, and the like. In an embodiment of the disclosure, the one or more updated transmission parameters are shared with the UE 200 as part of information communication frames, such as channel state information (CSI) indication, downlink control information (DCI) information block, and the like. Further, the one or more processors 202 may be configured to select the channel estimation technique based on the received channel information and the received one or more updated transmission parameters.

In an embodiment of the disclosure, the gNB at the decision engine may categorize the channel based on the necessity/severity for the one or more transmission parameters to be estimated. The decision engine may employ one or more techniques for the categorization, such as, without limitation, experiments-based threshold techniques, machine learning-based decision techniques, convolutional neural network (CNN), recurrent neural network (RNN) based evolutionary decision models for decision, and the like.

Further, in selecting the channel estimation technique based on the received channel information, the one or more processors 202 may be configured to determine that the received channel information indicates a less varying channel. Further, the one or more processors 202 may be configured to select a least computation and low complexity channel estimation technique upon determining that the received channel information indicates the less varying channel. In an embodiment of the disclosure, the least computation and low complexity channel estimation technique corresponds to a least squares technique.

Furthermore, in selecting the channel estimation technique based on the received channel information, the one or more processors 202 may be configured to determine that the received channel information indicates a moderate varying channel. Further, the one or more processors 202 may be configured to select a moderate computation and moderate complexity channel estimation technique upon determining that the received channel information indicates the moderate varying channel. In an embodiment of the disclosure, the moderate computation and moderate complexity channel estimation technique corresponds to a minimum mean square error (MMSE) technique.

Further, in selecting the channel estimation technique based on the received channel information, the one or more processors 202 may be configured to determine that the received channel information indicates a high varying channel. Further, the one or more processors 202 may be configured to select a high computation and high complexity channel estimation technique upon determining that the received channel information indicates the high varying channel. In an embodiment of the disclosure, the high computation and high complexity channel estimation technique corresponds to a discrete cosine transform (DCT) technique or a discrete fourier transform (DFT).

In an embodiment of the disclosure, the one or more processors 202 may be configured to select parameter values associated with the DS_{desired} based on the channel type and delay spread conditions, as shown in Table 2. These parameters may be considered as an input to the decision engine if AI-based models, such as CNN, RNN, deep neural network (DNN) etc. The one or more network parameters enable the AI-based models to take decisions for the channel categorization. Also, the one or more parameters are supplemented by the similar parameters calculated by the gNB using the uplink frames. Examples of similar parameters may include, but not limited to, channel state information, signal-to-noise ratio, and timing offset.

TABLE 2

| | | Approximate |
|---|---|---|
| Channel Type | Delay spread conditions | parameter values |
| Frequent | Long or Very Long delay | 300 to 1000 ns spread |
| changing channel | spread | and more |
| Moderate | Short or Nominal delay | 30 to 300 ns spread |
| changing channel | spread | |
| Low changing | Very short or short delay | 10 to 30 ns spread |
| channel | spread | |

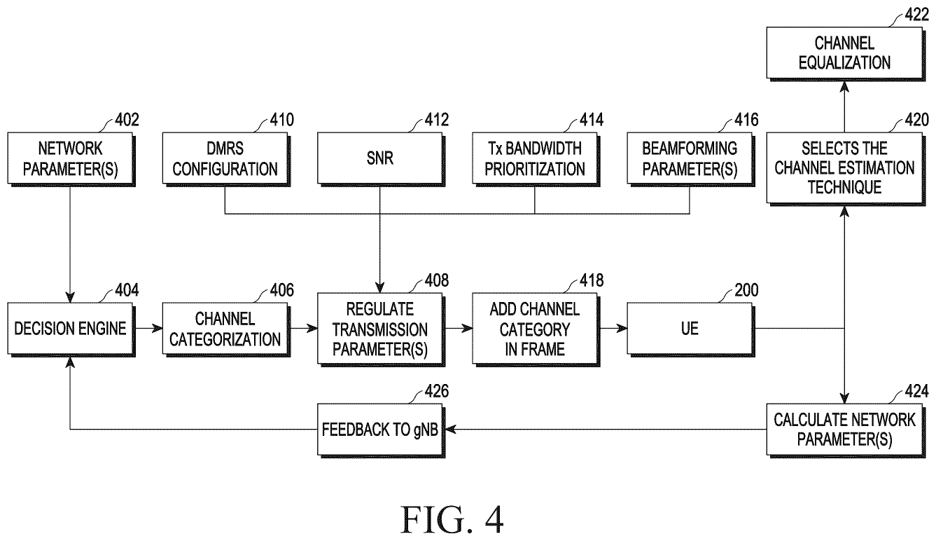

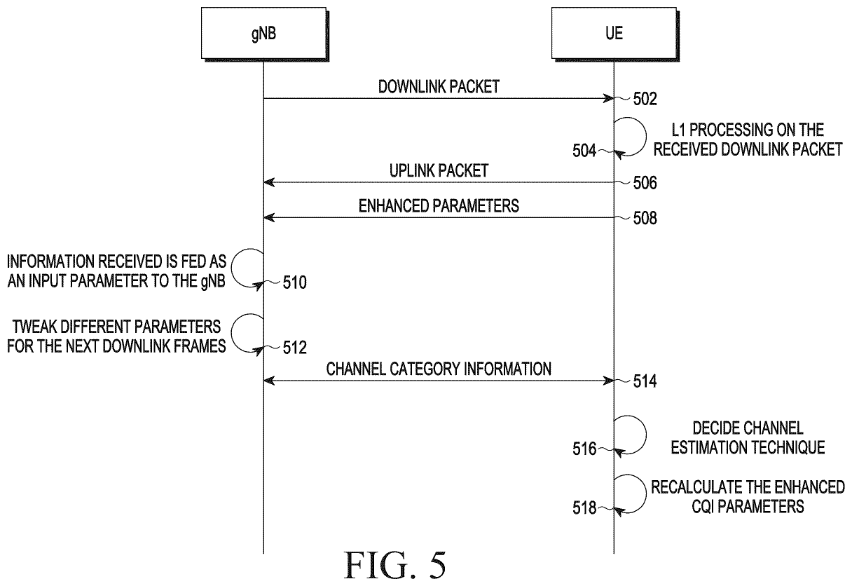

Furthermore, the one or more processors 202 may be configured to determine that a previously used channel is optimal for the physical layer processing based on the received channel information. The one or more processors 202 may be configured to perform the physical layer processing using the previously used channel upon determining that the previously used channel is optimal for the physical layer processing. Details on the operation of the UE 200 have been explained with reference to at least FIGS. 4 and 5.

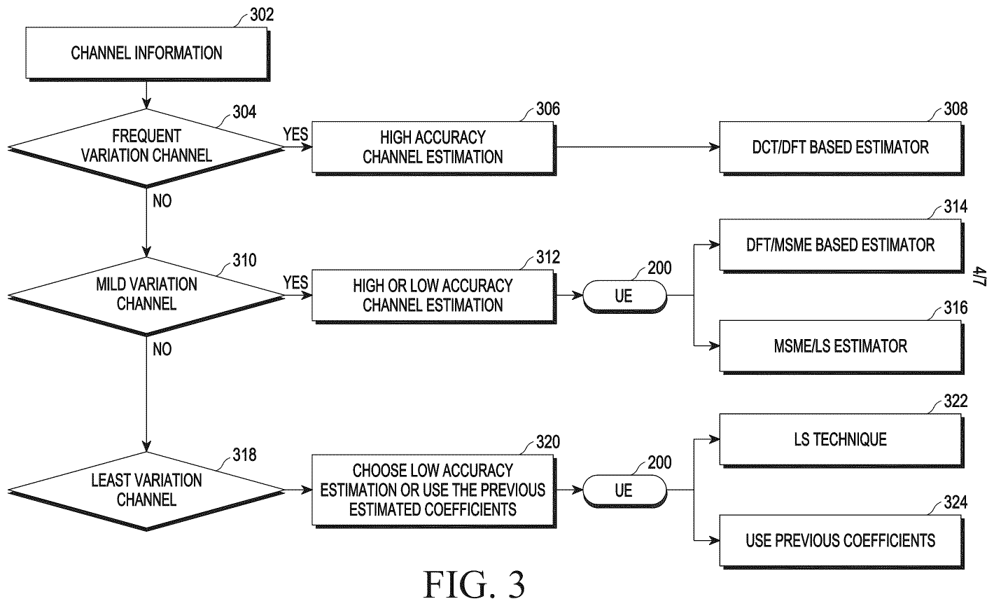

FIG. 3 is a flowchart illustrating example technique for selecting a channel estimation based on channel information, according to various embodiments. The selection of the channel estimation technique are explained with reference to FIG. 2.

At operation 302, the UE 200 receives the channel information from the gNB. In an embodiment of the disclosure, the channel information is computed using the CQI report, the one or more network parameters, and the uplink packet. At operation 304, the system determines that the received channel information indicates the frequent/high varying channel. Further, at operation 306, the system selects the high computation and high complexity channel estimation technique (e.g., the MSME) upon determining that the received channel information indicates the high varying channel. In an embodiment of the disclosure, the high computation and high complexity channel estimation technique corresponds to the DCT technique or the DFT technique 308.

At operation 310, the system determines that the received channel information indicates the moderate/mild varying channel. The system at operation 312 selects the moderate computation and moderate complexity channel estimation technique (e.g., a high or low accuracy channel estimation) (e.g., MSME or least square) upon determining that the received channel information indicates the moderate varying channel. In an embodiment of the disclosure, the selection module of the UE 200 uses the MMSE technique/DFT technique 314 or the MMSE technique/the least square (LS) technique 316.

At operation 318, the system determines that the received channel information indicates a less varying channel. The system at operation 320 selects the least computation intensive and low complexity channel estimation technique, use the previous estimated coefficients, and estimates after a certain number of frames or as per the channel parameter communicated by the gNB upon determining that the received channel information indicates the less varying channel. In an embodiment of the disclosure, this decision may be altered based on situations. For example, when the UE 200 experiences continuous CRC check failures. In an embodiment of the disclosure, the selection module of the UE 200 uses the LS technique 322 or use the previous estimated coefficients 324.

FIG. 4 is a diagram illustrating example operations performed by the UE 200 for performing the channel estimation, according to various embodiments. Details on performing the channel estimation are explained with reference to FIG. 2.

As depicted, at operation 402, the gNB receives one or more network parameters (e.g., locally calculated channel parameters) from the uplink frames. Further, the decision engine 404 at the gNB performs the channel categorization at operation 406 e.g., the frequent variation channel, mild variation channel, least variation channel, and the like.

At operation 408, the gNB regulates the one or more transmission parameters on an optional basis. In an example embodiment of the disclosure, the one or more transmission parameters include the DMRS configuration 410, signal-to-noise ratio (SNR) 412 for the one or more transmission parameters, the transmission (Tx) bandwidth prioritization 414, and the one or more beamforming parameters 416.

At operation 418, the gNB adds the channel category in a transmission frame for the UE 200 and transmits the transmission frame to the UE 200. At operation 420, the UE 200 selects the channel estimation technique based on the received channel category information. Furthermore, at operation 422, the UE 200 performs the channel equalization to recover actual transmitted data. At operation 424, the UE 200 calculates the one or more network parameters, such as the estimated frequency offset, the phase offset, the observed Doppler shift, the SINR, and the like. The UE 200 transmits the one or more network parameters to the gNB via the CQI report or DCI information frames, at operation 426. Furthermore, the gNB performs the channel categorization based on the received CQI report or the DCI information frames (e.g., operations 402-426 are continuously repeated).

FIG. 5 is a signal flow diagram illustrating example operations performed by the UE 200 for performing the channel estimation, according to various embodiments. Details on performing the channel estimation are explained with reference to FIG. 2.

At operation 502, the gNB sends a downlink packet to the UE 200 (may be any downlink packet). On reception, the UE 200 performs the L1 processing on the received downlink packet, and calculate different parameters, such as SNR, frequency offset, phase offset, and the like based on the received downlink packet for the enhanced CQI reporting, at operation 504. In an embodiment of the disclosure, the UE 200 has multiple channel estimation techniques, such as high computation intensive technique, mild computation intensive technique, low computation intensive technique, and the like. In parallel, at operation 506, the UE 200 my send any uplink packet to the gNB since it is a duplex system. This packet may also be analysed by the gNB at the L1 processing stage to derive the respective channel information. In an embodiment of the disclosure, the UE 200 derives the enhanced CQI parameters, such as frequency offset, phase offset, and the like. After deriving the enhanced CQI parameters from the downlink packet, the

UE 200 gives these enhanced parameters as feedback to the gNB using a CQI indication, at operation 508. At operation 510, the information received at the gNB from operations 506 and 508 is fed as an input parameter to the decision engine at the gNB. Further, the decision engine of the gNB intelligently performs the channel categorization.

At operation 512, this channel category information may also be used by the gNB to tweak different parameters for the next downlink frames, such as DMRS configuration, SINR, beam forming parameters, and the like. At operation 514, the channel category information is communicated to the UE 200 using DCI/CSI reporting (or any other reporting as configured). On the reception of the CCI, the UE 200 decides which channel estimation technique to use, or if the previously estimated channel may be reused for L1 processing, at operation 516. In parallel, the UE 200 recalculates the enhanced CQI parameters at operation 518 and reports them as feedback to the gNB as done at operation 508. Further, the system is a feedback assisted robust way to decrease the L1 processing time and power consumption at the same time

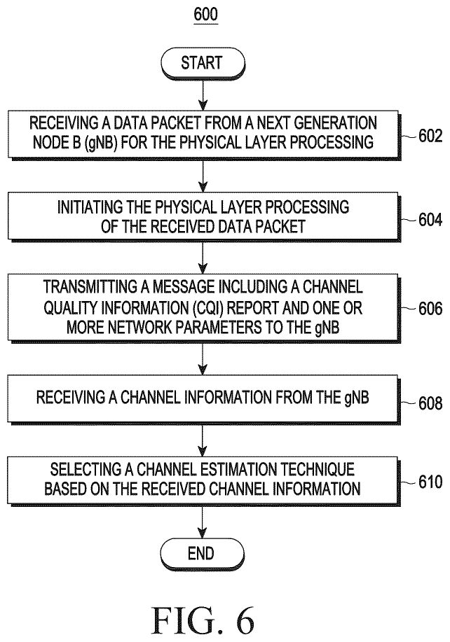

FIG. 6 is a flowchart illustrating an example method for performing the channel estimation, according to various embodiments. The method 600 as shown in FIG. 6 is implemented in the UE 200 for performing the channel estimation.

At operation 602, the method 600 includes receiving a data packet from a Next Generation Node B (gNB) for the physical layer processing.

At operation 604, the method 600 includes initiating the physical layer processing of the received data packet.

At operation 606, the method 600 includes transmitting a message including a channel quality information (CQI) report and one or more network parameters to the gNB. In an example embodiment of the disclosure, the one or more network parameters an estimated frequency offset, a phase offset, an observed Doppler shift, or any combination thereof.

At operation 608, the method 600 includes receiving channel information from the gNB. In an embodiment of the disclosure, the channel information is computed using at least one of the CQI report, the one or more network parameters, and an uplink packet received by the gNB from the UE 200 on an uplink channel.

At operation 610, the method 600 includes selecting a channel estimation technique based on the received channel information. In selecting the channel estimation technique based on the received channel information, the method 600 includes receiving one or more updated transmission parameters from the gNB. In an embodiment of the disclosure, the one or more transmission parameters are updated by the gNB based on the channel information. In an example embodiment of the disclosure, the one or more updated transmission parameters include demodulation reference signal (DMRS) configuration, signal-to-noise ratio for one or more transmission parameters, transmission bandwidth prioritization, one or more beamforming parameters, and the like. Further, the method 600 includes selecting the channel estimation technique based on the received channel information and the received one or more updated transmission parameters.

In selecting the channel estimation technique based on the received channel information, the method 600 may include determining that the received channel information indicates a less varying channel. The method 600 may include selecting a least computation and low complexity channel estimation technique upon determining that the received channel information indicates the less varying channel. In an embodiment of the disclosure, the least computation and low complexity channel estimation technique corresponds to a least squares technique.

In selecting the channel estimation technique based on the received channel information, the method 600 may include determining that the received channel information indicates a moderate varying channel. The method 600 may include selecting a moderate computation and moderate complexity channel estimation technique upon determining that the received channel information indicates the moderate varying channel. In an embodiment of the disclosure, the moderate computation and moderate complexity channel estimation technique corresponds to a minimum mean square error (MMSE) technique.

In selecting the channel estimation technique based on the received channel information, the method 600 may include determining that the received channel information indicates a high varying channel. The method 600 may include selecting a high computation and high complexity channel estimation technique upon determining that the received channel information indicates the high varying channel. In an embodiment of the disclosure, the high computation and high complexity channel estimation technique corresponds to one of a discrete cosine transform (DCT) technique or a discrete Fourier transform (DFT).

The method 600 may include transmitting, upon completing the physical layer processing, the data packet to an upper layer of the UE 200 based on the selected channel estimation technique.

The method 600 may include determining that a previously used channel is optimal for the physical layer processing based on the received channel information. The method 600 may include performing the physical layer processing using the previously used channel upon determining that the previously used channel is optimal for the physical layer processing.

While the above steps/operations shown in FIG. 6 are described in a particular sequence, the steps/operations may occur in variations to the sequence in accordance with various embodiments of the disclosure. Further, the details related to various steps/operations of FIG. 6, which are already covered in the description related to FIGS. 2-5 are not repeated in detail here for the sake of brevity.

The disclosure provides for various technical advancements based on the key features discussed above. Further, the disclosure targets the reduction of computation and power requirements of communication systems. The continuous, frequent and precise estimation of channel coefficients are not required in real time for each frames received. The disclosure intelligently regulates the aspect of reducing the power consumption and time demand without hampering the robustness of the disclosure. The case when UE decides to skip power for a few of the frames saves about 15% of the power consumption of the L1 processing operation considering the reference symbols to be processed of about this percentage of a target frame. For example, two reference symbols per transmission time interval (TTI) are considered. Since the mathematical calculations are much complex, saving these computation may show a significant power gain. Also, since the input parameters like reference symbols configuration are again depending on the channel categorization, the power saving number may increase in case higher order or more dense reference symbols are used. Since the channel estimation techniques are intelligently varied, the disclosure may be more power robust and fault robust, than that of the one running on either single computation intensive technique (consumes more power) or less computation intensive technique (more fault prone). Since the decision engine at the gNB uses the enhanced CQI parameters and the locally calculated parameters, the decision engine has better intelligence to predict the right channel condition for a particular UE. In the case of channel prioritization, the disclosure promotes a less frequently changing channel thus making the disclosure more adaptive and power efficient.

Further, the disclosure discloses a technique to intelligently lessen the overhead of estimating channel for each frame received for physical layer processing. The disclosure may reduce the computation as at the high frequency the time for one slot is less. Furthermore, the disclosure is useful for power consumption. The disclosure is also useful to increase the amount of data per frame by reducing the reference symbols.

While specific language has been used to describe the disclosure, any limitations arising on account of the same are not intended. As would be apparent to a person in the art, various working modifications may be made to the method in order to implement the disclosed concept.

The drawings and the forgoing description give example embodiments. Those skilled in the art will appreciate that one or more of the described elements may well be combined into a single functional element. Certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the disclosure or not, such as differences in structure, dimension, and use of material, are possible. The scope of embodiments is at least as broad as given by the following claims.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method implemented in a user equipment (UE) for channel estimation in physical layer processing, the method comprising:
receiving a data packet from a next generation node B (gNB) for the physical layer processing;
initiating the physical layer processing of the received data packet;
transmitting a message including at least one channel quality information (CQI) report and one or more network parameters to the gNB;
receiving channel information from the gNB, wherein the channel information is identified using the at least one of the CQI report, the one or more network parameters, and an uplink packet transmitted by the UE on an uplink channel; and
selecting a channel estimation technique based on the received channel information.

2. The method as claimed in claim 1, further comprising:
transmitting, upon completing the physical layer processing, the data packet to an upper layer of the UE based on the selected channel estimation technique.

3. The method as claimed in claim 1, wherein the one or more network parameters include at least one of an estimated frequency offset, a phase offset, and an observed Doppler shift.

4. The method as claimed in claim 1, wherein selecting the channel estimation technique based on the channel information comprises:
receiving one or more updated transmission parameters from the gNB, wherein the one or more transmission parameters are updated by the gNB based on the channel information, and wherein the one or more updated transmission parameters comprise demodulation reference signal (DMRS) configuration, signal-to-noise ratio for one or more transmission parameters, transmission bandwidth prioritization, and/or one or more beamforming parameters; and
selecting the channel estimation technique based on the channel information and the updated one or more transmission parameters.

5. The method as claimed in claim 1, wherein selecting the channel estimation technique based on the channel information comprises:
determining that the channel information indicates a less varying channel; and
selecting a least computation and low complexity channel estimation technique based on determining that the channel information indicates the less varying channel, wherein the least computation and low complexity channel estimation technique corresponds to a least squares technique.

6. The method as claimed in claim 1, wherein selecting the channel estimation technique based on the channel information comprises:
determining that the channel information indicates a moderate varying channel; and
selecting a moderate computation and moderate complexity channel estimation technique based on determining that the received channel information indicates the moderate varying channel, wherein the moderate computation and moderate complexity channel estimation technique corresponds to a minimum mean square error (MMSE) technique.

7. The method as claimed in claim 1, wherein selecting the channel estimation technique based on the channel information comprises:
determining that the received channel information indicates a high varying channel; and
selecting a high computation and high complexity channel estimation technique based on determining that the received channel information indicates the high varying channel, wherein the high computation and high complexity channel estimation technique corresponds to a discrete cosine transform (DCT) technique and/or a discrete Fourier transform (DFT).

8. The method as claimed in claim 1, further comprising:
determining that a previously used channel is optimal for the physical layer processing based on the channel information; and
performing the physical layer processing using the previously used channel based on determining that the previously used channel is optimal for the physical layer processing.

9. A user equipment (UE) for channel estimation in physical layer processing, the UE comprising:
memory storing instructions; and
at least one processor, comprising processing circuitry,
wherein the instructions, when executed by at least one processor individually and/or collectively, cause the UE to:
receive a data packet from a next generation node B (gNB) for the physical layer processing;
initiate the physical layer processing of the received data packet;
transmit a message including at least one channel quality information (CQI) report and one or more network parameters to the gNB;
receive a channel information from the gNB, wherein the channel information is identified using the at least one of the CQI report, the one or more network parameters, and an uplink packet transmitted by the UE on an uplink channel; and
select a channel estimation technique based on the received channel information.

10. The UE as claimed in claim 9, wherein the instructions, when executed by at least one processor individually and/or collectively, cause the UE to transmit, based on completing the physical layer processing, the data packet to an upper layer of the UE based on the selected channel estimation technique.

11. The UE as claimed in claim 9, wherein the one or more network parameters include at least one of an estimated frequency offset, a phase offset, and an observed Doppler shift.

12. The UE as claimed in claim 9, wherein in selecting the channel estimation technique based on the channel information, the instructions, when executed by at least one processor individually and/or collectively, cause the UE to:
receive one or more updated transmission parameters from the gNB, wherein the one or more transmission parameters are updated by the gNB based on the channel information, and wherein the one or more updated transmission parameters comprise demodulation reference signal (DMRS) configuration, signal-to-noise ratio for one or more transmission parameters, transmission bandwidth prioritization, and one or more beamforming parameters; and
select the channel estimation technique based on the channel information and the updated one or more transmission parameters.

13. The UE as claimed in claim 9, wherein, for selecting the channel estimation technique based on the channel information, the instructions, when executed by at least one processor individually and/or collectively, cause the UE to:
determine that the channel information indicates a less varying channel; and
select a least computation and low complexity channel estimation technique based on determining that the channel information indicates the less varying channel, wherein the least computation and low complexity channel estimation technique corresponds to a least squares technique.

14. The UE as claimed in claim 9, wherein, for selecting the channel estimation technique based on the channel information, the instructions, when executed by at least one processor individually and/or collectively, cause the UE to:
determine that the channel information indicates a moderate varying channel; and
select a moderate computation and moderate complexity channel estimation technique based on determining that the received channel information indicates the moderate varying channel, wherein the moderate computation and moderate complexity channel estimation technique corresponds to a minimum mean square error (MMSE) technique.

15. The UE as claimed in claim 9, wherein, for selecting the channel estimation technique based on the channel information, the instructions, when executed by at least one processor individually and/or collectively, cause the UE to:
determine that the received channel information indicates a high varying channel; and
select a high computation and high complexity channel estimation technique based on determining that the received channel information indicates the high varying channel, wherein the high computation and high complexity channel estimation technique corresponds to a discrete cosine transform (DCT) technique and/or a discrete Fourier transform (DFT).

16. The UE as claimed in claim 9, wherein the instructions, when executed by at least one processor individually and/or collectively, cause the UE to:
determine that a previously used channel is optimal for the physical layer processing based on the channel information; and
perform the physical layer processing using the previously used channel upon determining that the previously used channel is optimal for the physical layer processing.

17. A non-transitory computer-readable storage medium storing one or more programs comprising instructions to, when executed by at least one processor of a user equipment (UE) individually or collectively, cause the UE to:
receive a data packet from a next generation node B (gNB) for the physical layer processing;
initiate the physical layer processing of the received data packet;
transmit a message including at least one channel quality information (CQI) report and one or more network parameters to the gNB;
receive a channel information from the gNB, wherein the channel information is identified using the at least one of the CQI report, the one or more network parameters, and an uplink packet transmitted by the UE on an uplink channel; and
select a channel estimation technique based on the received channel information.

18. The non-transitory computer-readable storage medium of claim 17, the instructions, when executed by at least one processor individually and/or collectively, cause the UE to transmit, based on completing the physical layer processing, the data packet to an upper layer of the UE based on the selected channel estimation technique.

19. The non-transitory computer-readable storage medium of claim 17, wherein the one or more network parameters include at least one of an estimated frequency offset, a phase offset, and an observed Doppler shift.

20. The non-transitory computer-readable storage medium of claim 17, the instructions, when executed by at least one processor individually and/or collectively, cause the UE to:
determine that a previously used channel is optimal for the physical layer processing based on the channel information; and
perform the physical layer processing using the previously used channel upon determining that the previously used channel is optimal for the physical layer processing.
